(19) United States
(12) Patent Application Publication
(10) Pub. No.: US 2004/0012847 A1
(43) Pub. Date: Jan. 22, 2004

(54) Displaceable optics in microscope illumination, particularly displaceable collector

(75) Inventor: Andreas Lesche, Jena (DE)

Correspondence Address: Gerald H. Kiel, Esq., REED SMITH LLP, 599 Lexington Avenue, New York, NY, 10022-7650, US

(73) Assignee: Carl Zeiss Microelectronic Systems GmbH

(21) Appl. No.: 10/615,698

(22) Filed: Jul. 9, 2003

(30) Foreign Application Priority Data
Jul. 9, 2002 (DE) 202 10 569.5

(51) Int. Cl. G02B 21/00

(52) U.S. Cl. 359/368

(57) ABSTRACT

Displaceable optics in microscope illumination, particularly a displaceable collector, comprising an outer guide sleeve and a preferably cylindrical optics housing which slides in the guide sleeve, characterized in that Teflon strips are provided between the optics housing and guide sleeve for flexible centering of the optics.

### CROSS-REFERENCE TO RELATED APPLICATION

This application claims priority of German Application No. 202 10 569.5, filed Jul. 9, 2002, the complete disclosure of which is hereby incorporated by reference.

### BACKGROUND OF THE INVENTION

Correct illumination of a microscopic specimen is the most important prerequisite for careful microscopy and microphotography. The optical beam path in the microscope is usually based on Köhler illumination because this results in the greatest light intensity with uniform illumination of inhomogeneous, typically thermal light sources. The advantage of the Köhler illumination method is that the entire surface of the field diaphragm has the same luminance power as the small lamp filament itself: therefore, only low-voltage lamps are usually used.

The illuminated surface in the specimen corresponds to that of the field diaphragm in the eyepiece. This gives a maximum from the illumination beam path while simultaneously minimizing scattered light; uniformly illuminated specimens for an optimal resolution are therefore the special characteristics of this method of illumination.

A field diaphragm with adjustable aperture diameter is provided in the area of the beam path which is collimated by a collector disposed after the light source, this field diaphragm being arranged conjugate to the image plane of the microscope. A lens following the field diaphragm images the field diaphragm to infinity. A second diaphragm with adjustable aperture diaphragm is provided in the focal plane of the lens for adjusting the illumination aperture.

This aperture diaphragm is imaged to infinity through a lens arranged following it and is imaged in the exit pupil of the microscope objective after being mirrored into the observation beam path via a beam splitter through the tube lens in the common portion of the illumination beam path and observation beam path.

As a rule, the illumination lamp can be adjusted in several directions (three-dimensionally). A collector that is displaceable in direction of the optical axis in front of the lamp is also advantageous.

### SUMMARY OF THE INVENTION

For realizing this displacement, it is proposed in the following that the mounting of the collector optics, the collector housing, is displaceable in a guide sleeve and that Teflon strips are provided between the guide sleeve and the collector housing so as to ensure a flexible contact low in tolerances between the collector housing and guide sleeve, particularly also in the hot condition brought about by the light source.

### BRIEF DESCRIPTION OF THE DRAWING

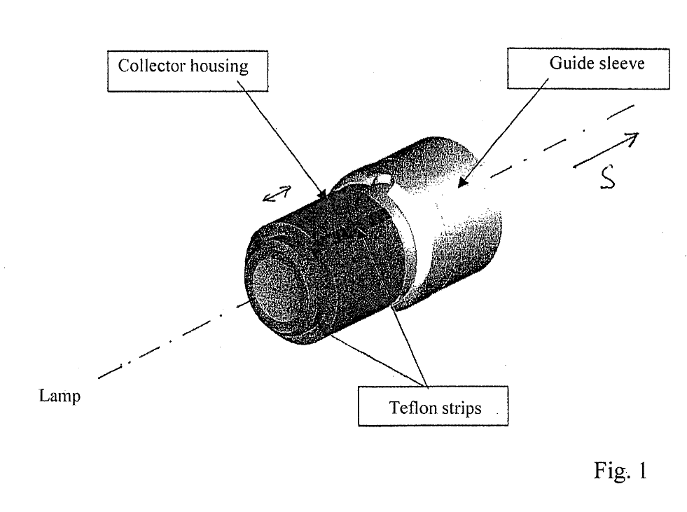

In a schematic view, FIG. 1 shows a beam path S which proceeds from a lamp in the direction of the arrow and in which a collector housing holding the collector optics is displaceable in a guide sleeve.

### DESCRIPTION OF THE PREFERRED EMBODIMENTS

In addition to the provision of Teflon strips between the guide sleeve and collector housing, at the same time, it is ensured through the selection of material that the collector housing and guide sleeve slide lightly against one another.

The Teflon strips advantageously have a mounting direction that coincides with the optical axis and the displacing direction of the collector housing so as to enable guiding at a long guide base without jolts.

Further, at least two oppositely located pairs of strips are advantageously provided, so that a good centering effect is automatically achieved in all displacement positions. Aside from two pairs, i.e., strips arranged crosswise in relation to one another in cross section (not shown), it is also possible to provide more than two pairs, preferably uniformly distributed over the guide circumference, or an uneven quantity uniformly distributed over the circumference, for example, three strips offset by 120 degrees at the circumference.

The strips can be fastened in the interior of the guide sleeve or also fastened to the circumference of the collector housing. An advantage of fastening to the guide sleeve would be that different collectors could be used without every one needing to have Teflon strips.

The Teflon strips are advantageously glued on and are so dimensioned in height that they exert an elastic pressure on the surface guiding them.

For this purpose, the inner circumference of the guide sleeve and the outer circumference of the collector housing exhibit a sufficient difference ensuring the elastic effect.

As mentioned above, the FIGURE illustrates a beam path S proceeding from a lamp in the direction of the arrow and in which a collector housing is displaceable in a guide sleeve.

The way in which the displacement of the collector is controlled is not important in this connection; it can be effected manually or by motor. The Teflon strips, in this case, four Teflon strips arranged opposite one another in pairs, are arranged at the collector housing.

While the foregoing description and drawings represent the present invention, it will be obvious to those skilled in the art that various changes may be made therein without departing from the true spirit and scope of the present invention.

What is claimed is:

1. Displaceable optics in microscope illumination, such as a displaceable collector, comprising:
an outer guide sleeve;
a cylindrical optics housing which slides in the guide sleeve; and
Teflon strips being provided between the optics housing and guide sleeve for flexible centering of the optics.

2. Displaceable optics according to claim 1, wherein the Teflon strips are arranged parallel to the displacing direction of the optics housing.

3. Displaceable optics according to claim 1, wherein Teflon strips are provided in pairs opposite one another.

4. Displaceable optics according to claim 1, wherein an odd or even quantity of Teflon strips are uniformly distributed over the circumference of the optics housing.

5. Displaceable optics according to claim 4, wherein three Teflon strips are provided at a 120-degree offset relative to one another with respect to the circumference.

6. Displaceable optics according to claim 1, wherein the Teflon strips are arranged at the guide sleeve.

7. Displaceable optics according to claim 1, wherein the Teflon strips are arranged at the optics housing.

8. Displaceable optics according to claim 1, wherein the Teflon strips are glued on.
